(19) United States
(12) Patent Application Publication
(10) Pub. No.: US 2026/0220716 A1
(43) Pub. Date: Jul. 30, 2026

(54) AI SYSTEM FOR FINANCE AND INSURANCE PRODUCTS FOR REAL-TIME INTERACTION AND GENERATION OF TEXTUAL AND CONVERSATIONAL RESPONSES TO CUSTOMERS QUERIES AND METHOD RELATING THERETO

(71) Applicant: Sarvinder Singh, Parker, CO (US)

(72) Inventor: Sarvinder Singh, Parker, CO (US)

(21) Appl. No.: 19/033,689

(22) Filed: Jan. 22, 2025

Related U.S. Application Data
(60) Provisional application No. 63/623,866, filed on Jan. 23, 2024.

(51) Int. Cl. G06Q 40/08; G06Q 40/06

(52) U.S. Cl. CPC G06Q 40/0821; G06Q 40/0631

(57) ABSTRACT

This invention relates to an AI system for finance & insurance products for real-time interaction and generation of textual and conversational responses to customer's queries and method relating thereto. The system includes a user interface (390) having icons representing different F&I products and a customer can access information on any of the product by clicking on the corresponding icon. The AI system enables a customer to raise any additional query (405) in relation to any of the F&I products by entering the query in the chatbot (300) of the system. The system contextualizes and rephrases (430) the query using prompt engineering and Large Language Model (LLM) (520) like ChatGPT 4o and its later versions. The text of the rephrased query is subjected to sentiment analysis by analyzing the text of query so as to determine whether the sentiment is ‘positive’ or ‘negative’. This is followed by the similarity check of the rephrased query with the queries already present in “Contextual Response Index” (445). Where the sentiment is determined to be ‘positive’ and the similarity score is more than seventy percent, the textual response and video path as given to the corresponding similar earlier query present in the ‘Contextual Response Index’ (445), is provided as final response (475) to the present query of the customer. Where the similarity score is less than seventy percent and the sentiment is also ‘negative’, the response is generated by Retrieval Augmented Generation module and the sentiment-based statistics generated by Trivia module, are appended to the response. An integrated Avatar generation module provides textual and conversational response like a live person.

### CROSS REFERENCE TO RELATED APPLICATIONS

This application claims priority from U.S. provisional application no. 63/623,866 having a filing date of 23 Jan. 2024, the disclosure of which is incorporated herein by reference.

### TECHNICAL FIELD

The present invention relates to an AI system for Finance & Insurance products for real-time interaction and generation of textual and conversational responses to customer's queries and method relating thereto. Specifically, but without implying any limitation thereto, the invention relates to real-time interaction and generation of textual and conversational responses to customers queries, for Finance and Insurance products, in the Automotive Industries, The Finance & Insurance Products may herein be referred to as ‘F&I product(s)’ or simply as ‘product(s)’, and AI system may herein be referred to at some places as ‘Versa’. The AI system of the present invention actively engages customers with AI-generated products-related dialogues, offering customized product relevant information by text as well as by human-like conversation with sentiment-based statistical information regarding the repercussions of not buying of a particular F&I product.

### BACKGROUND OF THE INVENTION

In the ever-evolving landscape of interacting with customers for sales promotion of Finance and Insurance (F&I) products in the automotive industry, the traditional customer interaction systems in sales are characterized by conventional sales-promotional scripts and limited-choice interfaces which are unable to adapt to ever increasing diversity of F&I products. These systems, entrenched in decades-old practices, are unable to adapt to the customized needs and preference of individual customers, out of the available diverse F&I products. The finance managers have to rely on their own knowledge of diverse F & I products and their interactive, persuasive, and presentation skills to offer a comprehensive suite of products to customers in a consistent manner.

One of the key shortcomings of the traditional systems is that these systems rely on pre-set scripts and static interfaces and lack personalization in the sense that customer preferences are not ascertained on a real-time basis through dialogue with the customers so as to offer F&I products keeping in view preferences of each customer.

Another drawback of the traditional systems is that these systems are dependent on the knowledge, understanding, way of presentation and interactive skill of a finance manager to present all the relevant information on diverse products to a customer in a convincing manner. Further, the Finance Managers or sales manager may inadvertently overlook some of the important product details or their personal bias and emotions may influence their product recommendations which could lead to missed opportunities of sales.

Yet another drawback of the traditional systems is that finance managers generally fail to provide information to the customers on financial repercussions, missed opportunities and customized statistical information such as repair data, thefts, etc., in the geographical location of the customer so as to enable a customer to make an informed decision whether to buy or not to buy an F&I product.

Further drawback of the traditional systems is that these are slow and inefficient as finance managers attend to limited customers, one customer at a time, while other customers have to wait for their turn till a Finance Manager becomes free which can negatively impact a customer's satisfaction whereas the present system commences with providing a tablet to each customer so that while a customer is waiting they can run through the details of the different F&I products on their respective tablet and can get answers to any queries they have on any product. A further shortcoming of traditional systems is that these systems fail to effectively capture and utilize customer data and the history of past interactions to enhance future interactions with a customer, resulting in missed opportunities for personalized engagement and sales optimization.

U.S. Pat. No. 10,332,295 reports a method and system to generate a photorealistic, interactive rotatable 360-degree presentation of an object suitable for display on a computer or mobile device. The system enables businesses to advertise the products to potential consumers, allowing the potential customers to see more of the product than simple stationary pictures offer. When a viewer selects (e.g., clicks or taps) a hotspot, the interactive rotatable 360-degree presentation displays the creator's choice of a text message, close-up image, web page, or additional interactive rotatable 360-degree presentation. A user (e.g., a business, such as a car dealer) may also use the services of one of several service bureaus known as “feed providers.” A feed provider stores and transmits data about the user's products (e.g., stock of vehicles for a car dealer), including digital photos uploaded by the user's photographer. In the case of a car dealer, the feed provider makes the vehicle data for that particular car dealer, including links to downloadable copies of the photos, available in a “feed file,” typically in a comma-separated values (CSV) format. The method includes the steps of a user uploading photos of an object to a third-party feed provider; feed provider generating a feed file for that user that includes a list of photo URLs; feed provider transmitting the feed file to a server. The system then detects the arrival of the feed file, downloads the photos listed in the file, and reads user configuration settings for the user. In a standard hotspot, a user may indicate a name for the hotspot, an optional text description, optional close-up image, optional URL, and the (x, y) coordinates of the hotspot on each image of the 360-degree presentation where it is visible.

A limitation of the above-mentioned system is that the above reported system provides a 360-degree presentation of a vehicle to a potential customer and a car dealer to show close-up image and additional representations of the product showing different views of a vehicle instead of showing a simple and stationary picture of a product, with a view to advertising a product through computers and mobile devices for sales promotion of a vehicle. Thus, the system relates to sales promotion of vehicles and not to sales promotion of Finance and Insurance products relating to vehicles.

Another limitation of the above-reported system is that its function is limited to showing additional views of a vehicle. It is not an AI-based system and does not enable real-time dialogue between a customer and a finance manager for F&I products to ascertain preferences of a customer and offer personalized recommendations with cost implications and associated benefits and opportunities.

Further limitation of the above-reported system is that the system does not include any mechanism for storing or retrieving past history of interactions held with a customer to guide future interactions with a customer.

Still further limitation of the above-reported system is that the system does not enable a customer to enter his/her query, and the system has no AI based mechanism to link the query to large language models so as to provide response to the query raised by the customer on a real-time basis.

### OBJECTS OF THE PRESENT INVENTION

An object of the present invention is to provide an AI system for Finance & Insurance products for real-time interaction and generation of textual and conversational response to queries of the customer for sales promotion of finance and insurance products in automotive industry by actively engaging the customers intending to purchase a car or intending to purchase F&I products for a car already purchased by him/her, with AI-generated products-related dialogues simulating face-to-face human-like conversations.

Another object of the present invention is to provide an AI system wherein the system automatically displays the information about different F&I products, one by one on the screen of a tablet with a customer thereby providing accurate and complete information about each of the F&I products, in a consistent manner to each customer and wherein if a customer wants to revisit details of any F&I product, he/she can just click on the corresponding icon representing that product, on the user interface.

Still another object of the present invention is to provide a system wherein multiple customers can parallelly interact with the system, without any waiting time, to access information on a F&I Product, through user interface on their respective tablets and wherein the customers can remotely operate the user interface at any time as per his/her convenience, for which a link can be sent by the Finance Manager through SMS or through email.

Yet another object of the present invention is to provide an AI system wherein after viewing of the details of different F&I products by a customer, the system automatically shows a video to all customers showing the different maintenance actions required for keeping the car in roadworthy conditions so that the customer appreciates the importance of buying a F&I product and is thereby inclined to buy the F&I Product(s). After, the video is over, the system provides an alert message to the Finance Manager to take over the face-to-face interaction with the customer.

Still another object of the present invention is to provide an AI system wherein user interface on the right margin provides answers to such questions on specifics of F&I products which are frequently asked by various customers.

Further object of the present invention is to provide an AI system wherein customers can engage in interactions with the system in text-based chats or in real-time audio-video interactions.

Yet further object of the present invention is to provide an AI system wherein a customer can select a language for interaction with the system by switching on the desired language option selecting out of the language options provided on the top of the display screen on the user interface. Presently, the language enables a customer to interact with the system in English and Spanish languages, however, it is extendible to other desired languages.

Still further object of the present invention is to provide an AI system with a user interface which enables a customer to provide opportunities for playing some games after interacting with the system for every few F&I products which enable the customer to win a discount on a particular F&I product. The customer can avail themselves of these discount coupons on a specific F&I product by clicking on the corresponding discount icon on the user interface and apply for discounts. In this way the customer is kept engaged during interaction with the system to view the details of different F&I products.

Yet further object of the present invention is to provide an AI system which enables a customer to enter any further queries regarding any specific product(s) and the system enables optimization/contextualization of the queries using prompt engineering and an image of female character ‘Versa’ providing response on real-time basis, in conversational form, using fine-tuned Retrieval Augmented Generation (RAG) and a Large Language Model (LLM) like ChatGPT-4o and its later versions, and AI Avatar generation.

Even further object of the present invention is to provide an AI system which employs fine-tuned transformer model like Support Vector Machine, for sentiment analysis of a customer at the time of purchasing the product, by analyzing the text of query to determine whether customer's query reflects ‘positive’ sentiment in favor of purchasing the product or reflects ‘negative’ sentiment against the purchase of the product.

Still further object of the present invention is to provide an AI system which deploys advanced similarity search algorithm leveraging ‘cosine similarity’ and ‘Contextual Response Index’ to reduce response latency and when the query vector is present in the ‘Contextual Response Index’ and matching score between the query vector and the stored vector in ‘Contextual Response Index’ exceeds seventy percent and also the sentiment is positive, the textual response to the query and video path as given to the earlier similar query in the Vector store, are given as response to present query.

Yet a further object of the present invention is that when, after analyzing the text of the query, the sentiment of the customer is determined to be ‘negative’, for a specific F&I product, the system generates state-specific relevant statistics such as repair data, thefts, etc. to convince the customer to reconsider his/her stance towards F&I products.

Even further object of the present invention is to provide ‘Adaptive Learning Mechanism’ for real-time updating of ‘Contextual Response Index’ with new customer interactions.

Still a further object of the present invention is to provide an AI system which not only responds with text but has a face and human voice, thereby enabling conversation with the customer to make a customer feel personal and relatable.

### SUMMARY OF THE PRESENT INVENTION

The present invention relates to an AI system for Finance & Insurance (F&I) products for real-time interaction and generation of textual and conversational responses to customer's queries and method relating thereto. The system is herein, at some places, referred to as ‘Versa’ with a human face to provide conversational replies mimicking human voice, to customers. Specifically, but without implying any limitation thereto, the F&I products are relating to automotive industry. The AI system consistently presents to every customer a full range of available F&I products relating to vehicle which a customer intends to purchase or intends to buy F&I products for a vehicle already purchased. The system automatically presents to every customer, the information on each of F&I products by display on the screen of a tablet, made available to a customer. Further, if any customer, desires to revisit the details of any F&I product, he/she can do so by just click on to the corresponding icon representing that product, shown on the user interface of the system. Thus, the customer can have a broad overview of the information on each of the F&I products including the information on nature of protection afforded by each of F&I products. Further, several customers can parallelly view the information regarding different products on the screen of their tablets, which are made available to them, on receipt of their deal ID. The AI system thus empowers the sales team with a tool that consistently presents information on 100% of F&I products, gives 100% of the time to 100% of customers. Besides an overview of the different F&I products which is automatically presented to every customer, the customer can raise additional specific queries for any of the F&I products, on the chatbot provided in the system. The AI system, besides providing textual response to the query raised by a customer, has speech-to-text capabilities whereby a customer can also speak out his/her query, the system then processes such oral query and responds in real-time with textual response as well as spoken answers which are delivered to the customer by ‘Versa’, a human face imitating human voice like a real-life conversation. A customer, thus, feels as though he/she is conversing with a live person. Multiple customers can interact parallelly with the system in English as well as Spanish language, by switching on the option provided on the top of the screen. The system is being extended for interaction by customers in other languages.

The system of the present invention has fine-tuned Retrieval Augmented Generation (RAG) as its brain, with which it delivers responses using a knowledge base. The knowledge base of the system contains meticulously compiled information from various sources, including Large Language Models like ChatGPT 4o and its later versions. To utilize this knowledge effectively, AI system creates chunks of data that are then embedded into an index called ‘Contextual Response Index”. The index is selected for its superior efficiency in handling large-scale data, its faster similarity search capabilities and its robust performance, ensuring that Versa can provide accurate and contextually relevant response in real time.

A standout feature of Versa is its sophisticated sentiment analysis capability, crucial in discerning a customer's hesitations during the purchasing process. This function adeptly analyzes the sentiment of rephrased queries and identifying the specific product under consideration. A Pandas query is used to provide detailed information including relevant statistics highlighting the impact of not purchasing a specific product. Thus, the customer, by analyzing the data presented to him/her, can better understand the benefits of buying a product and the repercussions and missed opportunities of not buying a product. In the light of these facts and figures, the customers may like to reconsider their stance. Once the sentiment analysis and trivia generation are complete, the final response, appended with relevant trivia, is processed through the Avatar Generation API, ensuring engaging and interactive customer experience.

When AI system receives a new query, it rapidly embeds the query and matches it against the entries in the ‘Contextual Response Index’ using ‘cosine similarity”. If a match is found with a similarity score exceeding 70%, Versa instantly retrieves the corresponding index, pulling the relevant LLM output and video path from the CSV file. This streamlined process reduces the latency to an impressive 1-2 seconds, offering a response speed that is far superior to traditional methods. This efficiency not only enhances a customer's experience but also makes Versa a leader in the conversational AI space, providing rapid and highly accurate responses.

### BRIEF DESCRIPTON OF FIGURES

The invention is illustrated with accompanying drawings which illustrate one embodiment in which the present invention can be practiced. It is to be understood that the drawings are intended to illustrate the invention and are not intended to be taken restrictively to imply any limitation on the scope of the present invention.

In the accompanying drawings:

FIG. 1: shows the user interface displaying icons representing different F&I products which enable a customer to revisit information on any of different F&I products by just clicking on to the corresponding representative icon and wherein the vehicle being purchased by the customer is displayed on the central portion of user interface display and wherein icons for availing discount coupons won by a customer during interaction with the AI system, are also displayed on the user interface screen..

FIG. 2: An example to show the information automatically provided by the System to every customer on F&I products which information can also be revisited by a customer, on clicking the corresponding representative icon, the example showing the information for one of the F&I products namely “Vehicle Service Contract”.

FIG. 3: shows ChatBot of the AI system for customer to enter any additional query for any particular product, showing an example of a query “What is Gap” and the response generated by the AI system of the present invention.

FIG. 4: shows flow chart for contextualizing and rephrasing of a customer's query.

FIG. 5: shows sentiment analysis, product extraction and Trivia generation regarding product-specific and state-specific statistical information, when sentiment is negative.

FIG. 6: shows flow chart for generating response to a query by the AI system of the present invention, when similarity match score between the present query and query already present in ‘Contextual Response Index’ is more than seventy percent.

FIG. 7: shows flow chart for generating response to a query by the AI system of the present invention, when similarity match score between the present query and query already present in ‘Contextual Response Index’ is less than seventy percent.

### DESCRIPTION OF INVENTION W.R.T DRAWINGS

The present invention relates to an AI system for Finance & Insurance (F&I) products for real-time interaction and generation of textual and conversational response to customer queries and method relating thereto, particularly but without implying any limitation thereto, for finance and insurance products in automotive industry. The system operates with the versatility of a live person, able to converse with the customers with voice and face mimicking human-voice and human-face and video capabilities, thereby enhancing engagement with the customers through personalized interactions. The AI system automatically and consistently presents every F &I product to every customer, without exception, explaining to the customers the protection afforded by each product, and benefits available on purchasing an F&I product, repercussions and missed opportunities when a F&I product is not purchased by a customer. The system employs fine-tuned sentiment analysis models and generates responses that are empathetic and persuasive aligning with the user's emotional state thereby enabling significant enhancement in the sales of F&I products in the automotive industry.

The AI system of the present invention comprises the following modules:

### User Interface Module

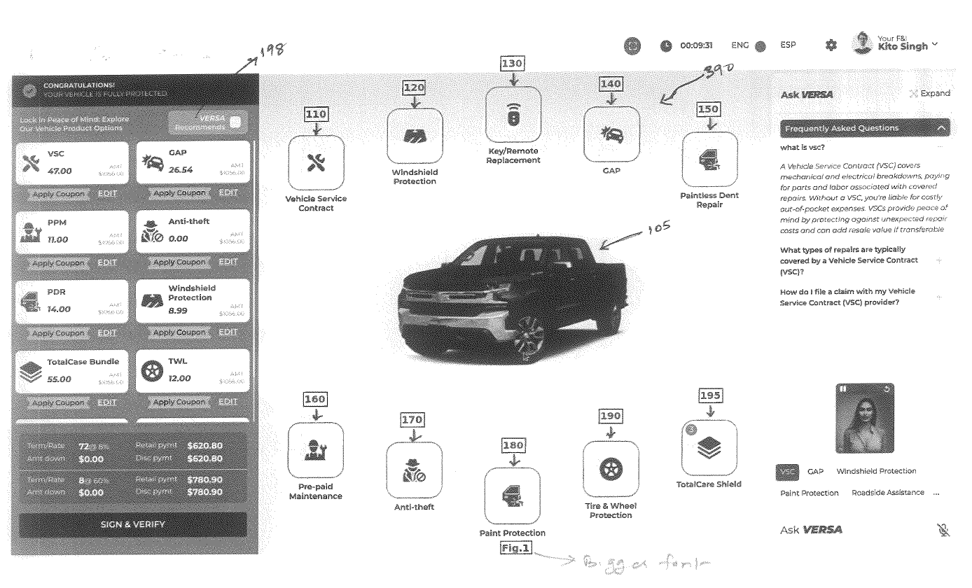

Referring to FIG. 1, the AI system of the present invention comprises a sophisticated User Interface (UI) (390) which has been designed and developed to enable a customer to interact independently and seamlessly in order to facilitate customer engagement.

Before a customer commences interaction with the system through the user interface (390), the system raises some pre-selected questions which are designed to assess the concern of the customer for maintaining the car, amount of usage of the car and his/her driving habits, which help in assessing customer's requirements for F&I products. When a customer says he/she does not need F&I products, the Finance Manager would say let us see what Versa recommends and would click on the button (198) “Versa Recommends” provided on the top-left side of user interface (390). Based on the answers to the pre-selected questions like above, provided by a customer, Versa would recommend certain F&I products which would be highlighted along with their costs. Based on these F&I products recommendations by Versa, the Finance Manager can emphasize the importance of these F&I products and would advise the customer to consider buying these products for hassle-free maintenance and to cope up with financial problems that may arise in the event of total loss of vehicle like theft.

When clicked, F&I products recommended by Versa, keeping in view the responses to preselected questions provided by a customer, would be highlighted along with their costs.

The pre-set questions may be like as given below, which are given for the sale of illustration only without implying any limitation.
1. Hey, what percentage of the time is your vehicle located indoors vs outdoor?
2. Data shows that drivers in New Jersey typically drive 10,000 miles per year, do you drive more or less than that?
3. Will you be adding this vehicle to your current insurance or shopping for a new policy?
4. Other than you, how many more individuals are of driving age in your household?
5. Are you planning to return to this dealership or visit one of those other locations for your oil changes?
6. Did you know, average trade cycle in New Jersey is 6 years. How long do you usually keep your vehicle?
7. How often do you schedule routine maintenance for your vehicle?
8. Hey, did you have to do any repairs on your current vehicle?
9. Have you done any cosmetic repairs on your vehicle?
10.Do you follow the factory recommended maintenance schedule for your vehicle?
11.Have you considered the potential costs of ongoing maintenance & unexpected repairs for your vehicle?
12.Are you worried about the future resale value of your car?

Continuing with reference to FIG. 1, the user interface displays icons (110, 120, 130, 140, 150, 160, 170, 180, 190, 195) representing different F&I products. The system also displays, at the central portion of display (as shown in FIG. 1), the image (105) of the car which the customer is intending to purchase or the car already purchased by him/her and he/she is looking for F&I products for the same. By this, the customer is assured that the F&I products being offered to him are all in relation to the car which he/she is intending to purchase or the car which he/she has already purchased. The particulars of car being purchased or already purchased by a customer, are captured by API integration through Dealership Management System (DMS). The particulars captured through DMS are shown to the customer to verify that the particulars displayed are factually correct and the system enables a customer to edit any of the displayed particular(s) which is/are not factually correct. The system then automatically displays information regarding each of F&I product, one by one, on the screen of tablet made available to a customer. After perusing all the screens of different F&I products, in case, a customer desires to revisit the particulars of any F&I product, he/she can do so by clicking on one of the icons (110, 120, 130, 140, 150, 160, 170, 180, 190, 195) on the user interface (390) which represents that product. By clicking on the relevant icon, the customer can view relevant information regarding a F&I product including the scope of protection afforded by each of the available F&I products and their associated financial benefits. The system also provides area-specific vehicle repair, damage and loss statistics and financial repercussions resulting from not purchasing a F&I product so as to enable the customer to take a well-informed decision on buying or not buying a F&I product.

The user interface (390) comprehensively and consistently displays information on different F&I products, one by one, on the screen of tablet(s) made available to each of customers. The complete range of F&I products includes Vehicles service contract (110), Windshield protection (120), Key/remote replacement (130), Guaranteed Asset Protection (GAP) (140), Paintless Dent repair (150), Pre-paid Maintenance (160), Anti-theft (170), Paint protection (180), Tire and wheel protection (190), and Total care shield (195). The User interface (390) thus, enables a customer to have a broad overview of protection provided by the different F&I products and their financial benefits, etc. by real-time interaction with the system in a short span of time.

Several customers can parallelly engage with the user interface (390) of the system to access the overall information on different F& I products as per an individual's vehicle purchase. In case a customer is not physically present at the office of Finance Manager, the link of the user interface can be sent to the customer by email or SMS so that the customer can remotely access the user interface from his location and view the information regarding different F&I products.

When a customer is viewing different F&I products displayed on the screen of a tablet made available to him/her, the system of present invention offers to the customer to play some games during the intervening periods between the display of two successive F&I products, so as to keep the customer engaged. A customer, by playing such games, can win some discount coupons on some F&I products, The user interface (390) has icons for applying for such coupons for discounts won by a customer by playing such games. A customer can apply for such coupon through the user interface by clicking in the corresponding representative icon displayed on the left side of screen, as shown in FIG. 1.

The display screen of user interface (390) also displays on the right side of screen. the answers to the frequently asked questions, for information of customers.

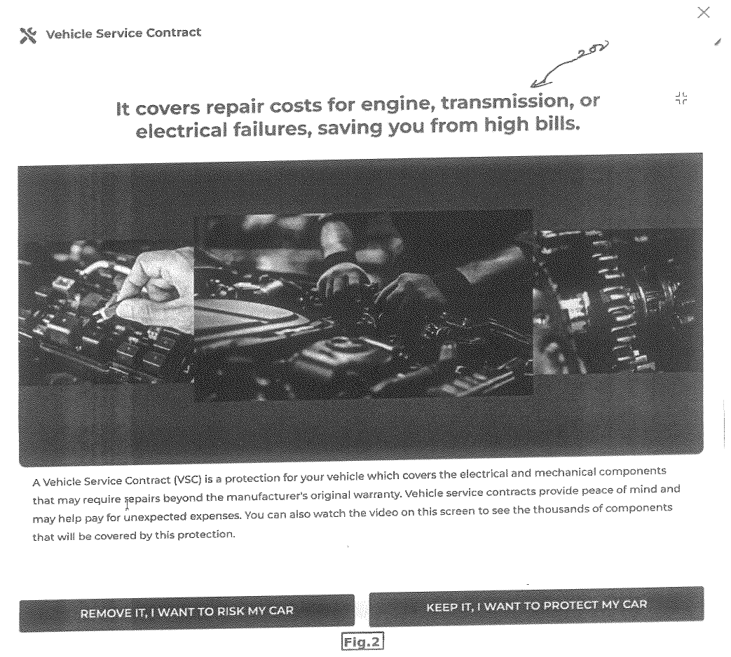

For the sake of illustration, the FIG. 2 shows the display screen (200) for one of the F&I products namely “Vehicle Service Contract”, Such information for each of the F&I product is automatically and consistently shown on the screens of tablets made available to different customers who approach with their deal ID. Further, in case a customer wishes to revisit the information on any of the F&I product, he/she can do so by clicking the representative icon for that desired F&I product through the User Interface. The customer can also watch a video on the screen for that F&I product, (PLEASE CHECK) on the screen of tablet made available to him/her.

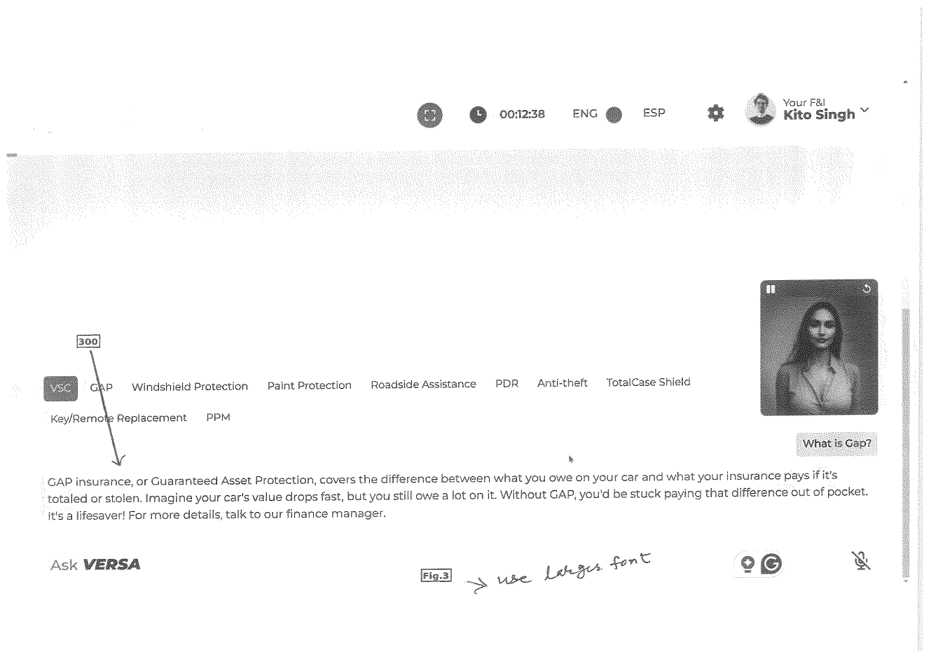

After having an overview of the available F&I products by operating user interface (390) as described above, in case a customer has still a query, the customer can raise such additional query in relation to any of the F&I products, by entering his/her query in a chatbot (300) as per example shown in FIG. 3. The customer can click on the representative icon of a product and enter his/her query in relation to that product, on the chatbot. As discussed in the succeeding paragraphs, the AI system of the present invention generates real-time textual and conversational response to the query of the customer.

The FIG. 3 shows an example of response generated by the system in response to a query by the customer on one of the F&I products namely: “What is Gap”. The query can either be entered on the chatbot or can be spoken to the system. The response generated by the AI system is shown in FIG. 3. The response (300) generated by the AI system of the present invention explains what is ‘Guaranteed Asset Protection’ (GAP), how it is useful and what is the scope of protection afforded by Gap. The AI system of the present invention enables to generate such response in textual or in conversation form to any query raised by a customer in relation to F&I products.

### Module for Contextualization and Rephrasing of Query

AI-driven system of the present invention leverages a Retrieval Augmented Generation (RAG) module which has been fine-tuned for F&I products for contextualization and rephrasing of queries raised by customers. The high-quality domain-specific data relating to Finance and Insurance Products is broken into chunks and embedded into vector representations using embedding models like text-embeddings-3-large. Each chunk of data is transformed into a numerical format, creating embeddings that represent the semantic meaning of the data. These embeddings are stored in a vector store, enabling efficient retrieval. When a query is made, the system generates an embedding of the query and performs a similarity search (such as cosine similarity) against the embedded chunks in the vector store to retrieve the most relevant information. The retrieved information is used to augment the input to the Large Language Model, like GPT 4o, as described in the succeeding paragraphs.

Several modifications have been made to the traditional RAG module, introducing novel modules that optimize its performance for a domain-specific i.e. F&I products in the automotive industry. These modules provide the following functionalities which are not present in traditional RAG implementations, and which enable query optimization:
Langchain's MongoDB chat history function has been leveraged to fetch the entire chat history for a specific customer stored in a MongoDB database, indexed by a unique deal ID. This function allows to maintain a persistent long-term memory of user interactions, ensuring that past conversations are accessible for context in future references and queries. This system creates long-term persistent storage that can recall prior interactions based on the deal ID, which is crucial for continuity in user interactions.
Once the entire chat history has been fetched from MongoDB, a custom short-term Window memory mechanism is introduced using Python's list slicing technique. This enables to dynamically retrieve only the most recent top-k messages from the full chat history (e.g., using chat history=chat history [-top k:]). This mechanism acts as a sliding window of recent conversation data and is used to rephrase user queries based on the latest chat context. This enables to achieve greater precision and control over query rephrasing, rather than just relying on Langchain's built-in behavior.

The combination of long-term persistent memory, stored in MongoDB, with a custom short-term memory window, as described above, enables a novel way to manage conversational history in a dynamic and context-aware manner. This allows for optimized query rephrasing based on automotive-specific content, improving the accuracy and relevance of the system's responses in a Domain Specific Setting. By organizing memory into long-term (persistent) and short-term (dynamic), an innovative layer of contextual control is added that extends beyond standard RAG frameworks.

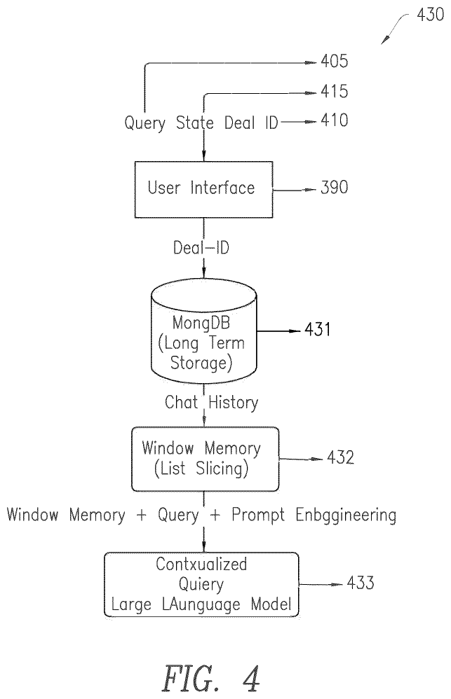

FIG. 4 shows the flow chart for contextualizing and rephrasing of a query (405) entered by a customer on the chatbot (300). A customer first interacts with the User Interface (390) for having an overview of all the different F&I products which are available, in relation to the car which he/she is purchasing or has purchased. When the Customer has an additional query, he/she enters the query (405) on chatbot (300), along with his/her location (415) and deal ID (410). The query (405), and deal (410) are passed on (how?) to the MongoDB (431) which is responsible for long term persistent storage of the Customer's chat history. The entire chat history of the customer, identified by his/her unique deal ID, is retrieved from the MongoDB (431). After fetching the chat history, long-term chat history is converted into short-term window memory (432) which includes the recent conversations, using ‘Slicing Operations’in Python's. For this purpose, list Slicing technique is employed to dynamically retrieve only the most recent top-k chats from the MongoDB (431), using the deal ID (410) of the customer. Then an API call to a Large Language Model (LLM) like ChatGPT4o and its later versions, is made using short-term window memory (432), user query (405) and using prompt engineering, to generate a contextualized rephrased query (433).

### Sentiment Analysis Module

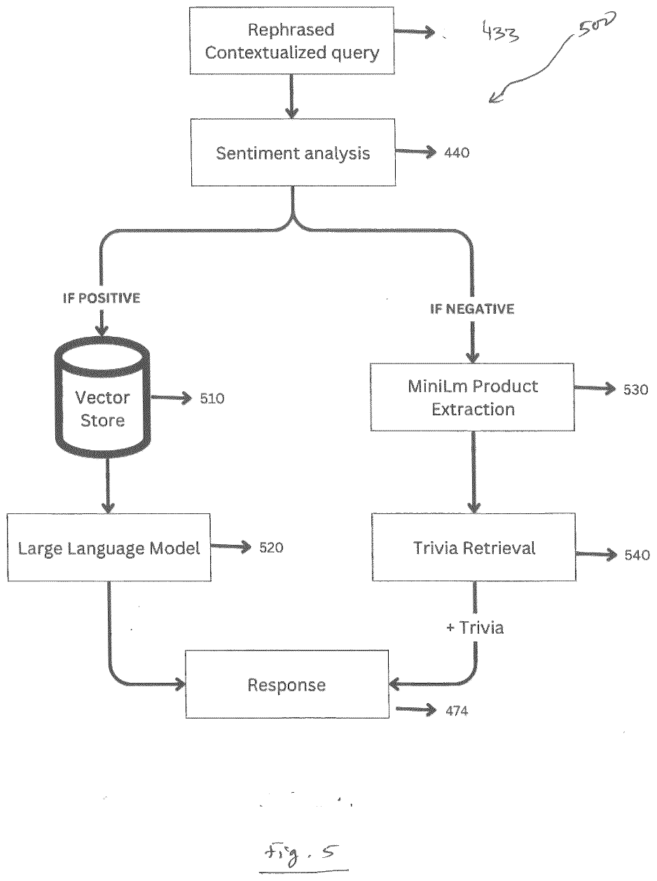

Referring to FIG. 5, the AI system of the present invention employs a transformer model like fine-tuned Support Vector Machine (440), for sentiment analysis. The model has been trained on Finance & Insurance-specific dataset using HuggingFace's “Trainer” API in Python to analyze the sentiment of customer's queries. The model analyzes the text of query to determine whether the customer's query reflects positive sentiment in favor of purchasing F&I products or negative sentiment i.e. against the purchasing of F&I product. The sentiment analysis influences how the system crafts its response to the customer's query.

The sentiment analysis ensures that the system understands nuanced, domain-specific, i.e. F&I products-related language, making response to a customer's query more precise and personal. By focusing on the sentiment of the customer, the system can adjust its tone and content, dynamically shifting responses based on the customer's mood or attitude.

Continuing with reference to FIG. 5, when the sentiment result of the rephrased contextualized query (433) from the sentiment analysis (440) is “positive”, the rephrased contextualized query (433) is passed through a vector store (510) which stores the data which acts as a knowledge base for the system. The data relating to F&I products in the text format is gathered from product brochures, internet and large language models such as GPT4o. The data is then chunked, embedded and stored in the Vector Store (510). The rephrased contextualized query (433) is compared with the relevant documents/data chunks in the Vector store (510). Vector store passes the relevant context to a large language model (520) like chatGPT4o and its later versions which then generates a text response (474) from sentiment based statistical response system which goes to AI avatar generation API.

Where the sentiment of the rephrased contextualized query (433) from the sentiment analysis module (440) is negative, the AI system of the present invention performs product extraction using “MiniLM” embedding model (530) which extracts the product from the contextualized and rephrased query (433). The said embedding model is used to create embeddings i.e. converting text into vectors. In this process, the query is embedded into a vector space alongside pre-stored Warranty product names that are similarly embedded. The system then uses cosine similarity, a mathematical equation to calculate the closeness between the query embedding and each product embedding. The F&I product with the highest cosine similarity score is extracted (530), ensuring that the product most semantically related to the query is chosen. This approach allows the system to identify the customer's implicit or explicit reference to specific products even when the query is ambiguous or emotionally charged. Once the product is extracted (530), the system proceeds to generate trivia or statistics relevant to the product and the customer's geographical location (415). The statistical information thus generated is then included in the response (474) from the sentiment based statistical response system which goes to AI avatar generation API.

### Module for Trivia Generation Based on Sentiment and Product

The Trivia system also known as Sentiment-Based Statistical Response system has a CSV (Comma Separated Values) file which has stored statistics based on product and state. When the sentiment of the query is determined by sentiment analysis as ‘Negative’, the product is extracted from the rephrased customer query using Minilm embedding model and then a Pandas search query is generated to fetch the trivia or statistics relevant to the product and the user's geographical location. This is achieved by determining the user's state from the initial API response, then writing a panda's query:
(trivia=df[(df[‘Product’]==product)&(df[‘State’]==state)][‘Trivia’].values), and employing Pandas to match the product and state with corresponding trivia from a predefined dataset from the CSV containing trivia data. Pandas is a structured data (for example: CSV, EXCEL, JSON etc.) manipulation tool in python language, which is used to do exploratory data analysis and data extraction using queries written in Pandas syntax.

The trivia is not only product-specific but also tailored to the customer's location, ensuring contextual relevance. For example, if the user expresses negative sentiment about a F&I product, the system might respond with state-specific statistics showing repercussions of not buying the product, providing statistically accurate data of casualties in the particular state to enable the customer to reconsider his/her stance in the light of facts and figures.

For instance, a user showing reluctance to buy the F&I product regarding ‘vehicle service contract’ which provides warranty beyond manufacturer's original warranty, might receive trivia showing that this warranty plan has saved drivers in their State, hundreds of dollars on average. Such personalized trivia adds a persuasive, fact-based layer to the conversation with the customer, making it highly relevant to the user's situation.

By leveraging cosine similarity to measure the semantic closeness of product names to user queries, the system ensures that it extracts the most contextually relevant product. The system compares embeddings with normalized vector magnitudes, allowing it to pick up on subtle relationships between the words used in queries and product descriptions. This matching process is crucial for driving the personalized trivia generation, ensuring the trivia is not generic but directly relevant to the user's sentiment and product needs.

The Sentiment-Based Statistical Response System represents a significant advancement over standard RAG pipelines, introducing several novel components:
(a) Automotive-Focused Sentiment Analysis: Utilizing fine-tuned transformer models for sentiment analysis, specifically designed for the automotive industry, this system offers tailored sentiment analysis that enhances understanding of user emotions and preferences.
(b) Semantic Product Extraction: By employing embedding models and cosine similarity, the system effectively identifies products that semantically align with customer queries, ensuring a more relevant and engaging interaction.
(c) Personalized Trivia Generation: The integration of extracted products with user location data enables the generation of contextually relevant trivia. This process yields personalized, domain-specific information that not only captivates customers but also encourages informed decision-making.

These unique features facilitate a highly dynamic and persuasive dialogue that adapts according to sentiment, provides personalized recommendations, and delivers statistically backed trivia. As a result, user engagement is significantly enhanced, leading to improved sales outcomes.

The ability to dynamically generate trivia that is both product-specific and location-specific is a groundbreaking addition to the RAG pipeline. By leveraging structured data in Pandas, the system can offer contextually relevant statistics, enriching its responses and tailoring them to the user's individual interests and circumstances and gives a unique twist on how AI can respond to emotional cues especially in a domain specific setting. This ultimately fosters a superior user experience and empowers users to make more informed decisions.

### Contextual Response Index (CRI)

The Contextual Response Index (CRI) is a novel component that significantly enhances the performance and efficiency of the system by effectively managing user interactions. It acts as a repository which contains pre-generated answers and associated videos in response to the earlier queries and matches the most relevant responses to the present customer's query. It performs the following functions:
(a) Data Management: The Contextual Response Index (CRI) systematically stores the user query, response, and the associated video path after each interaction. This structured data storage allows for rapid access to previously processed interactions, enabling the system to quickly reference past dialogues and responses.
(b) Reduced Response Times: By utilizing the Contextual Response Index (CRI), the system dramatically reduces response time from an average of 15-20 seconds to a mere 1-2 seconds. This improvement is crucial for maintaining customer engagement and satisfaction, as customers receive timely and relevant responses without unnecessary delays.
(c)Advanced Similarity Search Algorithms: the Contextual Response Index (CRI)

leverages advanced similarity search algorithms to efficiently retrieve relevant responses based on customer queries. Specifically, it employs “Cosine Similarity” which measures the cosine of the angle between two vectors—the query vector and the stored vectors in the CRI. The value of cosine similarity is higher as the similarity between two vectors increases till it becomes equal to one, when two vectors coincide, by determining the cosine similarity, the system assesses how closely related the current query is to previous interactions, facilitating precise retrieval.
(d) Data Storage Mechanism: The user queries, RAG-generated responses, and video paths are stored in a CSV file, which serves as a centralized data repository. Upon each interaction, the queries are embedded using the text-embedding-3-large model. This embedding transforms the textual queries into high-dimensional vectors, which represent their semantic meanings in a numerical format.
(e) Utilization of FAISS: To enhance the retrieval process, the embedded queries are integrated into the CRI using FAISS (Facebook AI Similarity Search) functions. FAISS is optimized for efficient similarity search and clustering of dense vectors, allowing for rapid identification of the closest matches between the embedded query and previously stored vectors in the CRI.
(f) Performance Improvement: The creation of the CRI, which allows for fetching and reusing similar past queries, provides a significant improvement in overall performance. By effectively managing data retrieval, the CRI ensures that responses are delivered quickly and accurately, enhancing the overall customer's experience.

### Adaptive Learning Mechanism

The Adaptive Learning Mechanism, which is inbuilt into the system, is responsible for populating the Contextual Response Index (CRI) with new user interactions, facilitating continuous updating and enhancement of the system.
(a) Automated Data Incorporation: Each time a new query is answered by the RAG, the corresponding response, user query, and associated video path are automatically incorporated into the CRI, ensuring real-time updates of CRI, without requiring manual input.
(b) Dynamic Data Management: This mechanism systematically updates the CRI to reflect the most current user interactions, creating a comprehensive repository of customers data.
(c) Feedback Loop Creation: It establishes an adaptive learning feedback loop that allows the system to refine its understanding of Customers preferences over time, thereby improving the relevance of subsequent responses.
(d) Real-Time Performance Optimization: By ensuring that the CRI is consistently updated, this mechanism enhances the overall performance of the system, leading to more accurate and timely responses.
(e) FAISS Utilization: The process of populating the CRI leverages FAISS (Facebook AI Similarity Search) functions for efficient storage and retrieval of embeddings, further enhancing system performance.

In summary, the Adaptive Learning Mechanism plays a crucial role in maintaining an up-to-date CRI, thereby enabling the system to learn from new interactions and adapt to user needs, ultimately improving user satisfaction and engagement.

### AI Avatar Generation

The AI Avatar Generation module introduces a new dimension to RAG chatbots and AI assistants, creating a truly human-like interaction experience. This innovative assistant combines visual, auditory, and textual communication, delivering a comprehensive 360-degree engagement that involves feedback collection that significantly enhances customer engagement. Its significant features include:
(a) Human-Like Presence: the AI system of the present invention not only responds with text but also has a face and voice, thereby enabling conversational interaction and thus making a customer feel more personal and relatable. This AI assistant can see, hear, and communicate with users in a way that mimics real human interaction, fostering a deeper connection.
(b) Multi-Sensory Communication: Customers can engage with the avatar through three distinct channels—watching the avatar speak, listening to its voice, and reading its text responses. This multi-modal approach enhances comprehension and retention, as users can absorb information in the way that feels most natural to them.
(c) Speech-to-Text Functionality: The AI avatar supports speech-to-text capabilities, allowing users to speak their questions or commands. The avatar processes this verbal input and responds in real-time with spoken answers, further imitating real-life conversations. This interaction method creates a seamless dialogue, making users feel as though they are conversing with a live person.
(d) Emotionally Sensitive Interaction: This advanced AI system is designed to be emotionally sensitive, recognizing and responding to the customer's tone and sentiment. By adapting its responses based on the customer's emotional state, the avatar enhances the conversation, providing empathetic and relevant feedback that resonates with the customer's feelings.
(e) Engaging Interaction: The AI avatar is not merely a static image; it brings conversations to life by expressing emotions and nuances that make interactions more engaging. Customers can experience a dynamic exchange, where the avatar responds to their queries in real time, offering a level of interaction that traditional chatbots simply cannot match.
(f) Personalized User Experience: The ability of the avatar to tailor its responses based on the customer's emotional tone, preferences, and needs adds a layer of personalization that enhances the overall experience. customers feel that they have been better understood, their sentiments valued, and their concerns given due attention, as the AI assistant having a face and human-like voice offers personalized dialogues.
(g) Seamless Integration: This cutting-edge avatar embodies the culmination of advanced technologies, merging query analysis, sentiment detection, and personalized responses into a single cohesive unit. The result is that the AI system acts like a true companion, ready to assist customers with information, recommendations, and engaging dialogue.

By offering a 360-degree interaction that encompasses sight, sound, and text, the AI Avatar Generation component transcends traditional chatbots, creating a vibrant and immersive experience.

### Method of Generating Real-time AI-Driven Textual and Conversational Response to Query

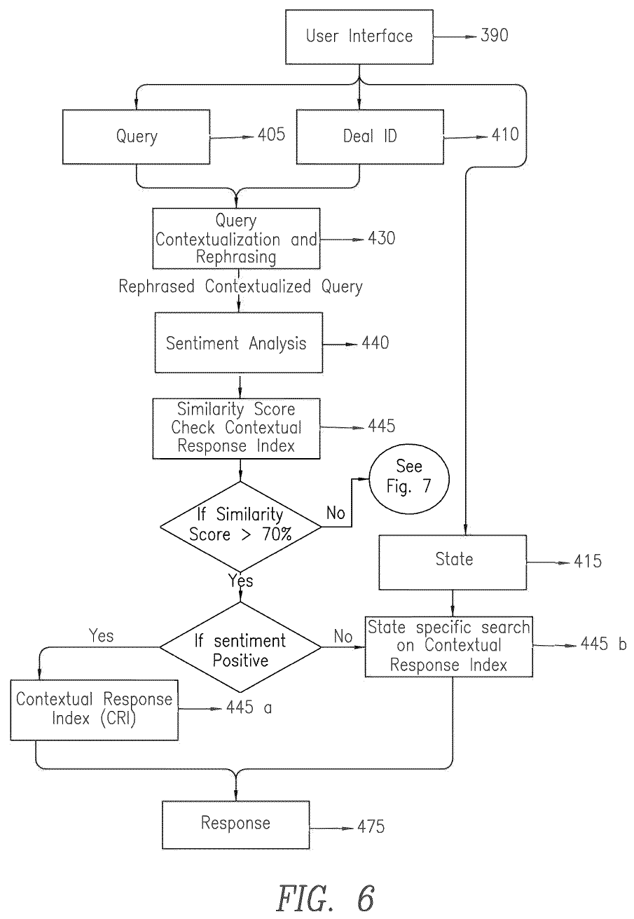

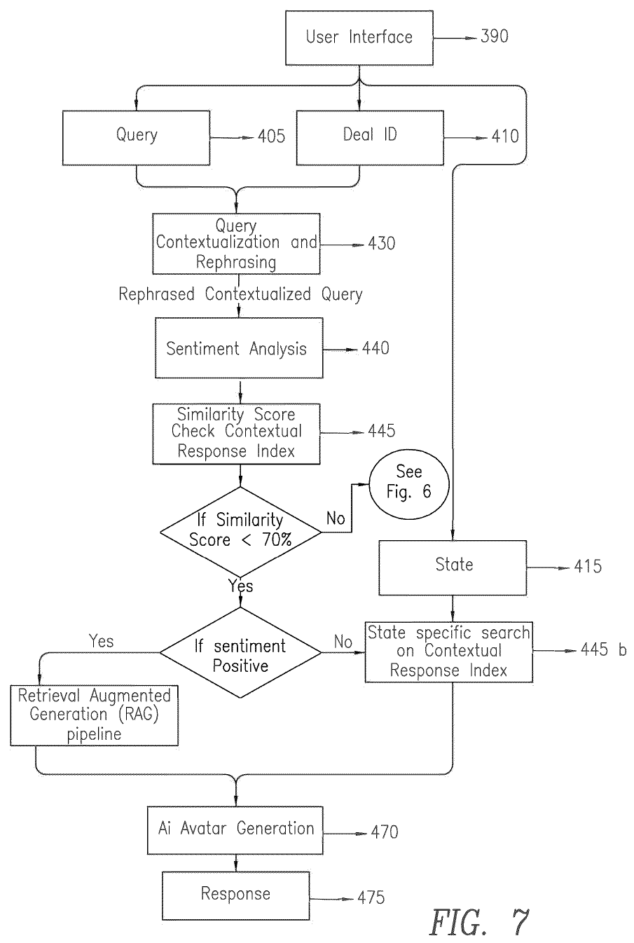

Referring to FIG. 6 and FIG. 7, a customer, by using the user interface (390), accesses the information on different available F&I products, as described above. When even after perusing the information on different F&I products, the customer has still any additional query regarding any of the F&I products, he/she can enter the query (405) along with his/her deal ID (410), on the chatbot (300) of the system. After the query is entered by the customer, the query undergoes contextualization and rephrasing (430), as described above with reference to FIG. 4. Thereafter, the text of query is subjected to sentiment analysis (440) using fine-tuned transformer model like Support Vector Machine (440), as described above with reference to FIG. 5. The sentiment analysis determines whether sentiment of the customer is ‘positive, or ‘negative’. This is followed by similarity check with the ‘Contextual Response Index’ (445) to check whether a query similar to the rephrased query (430) is already present ‘Contextual Response Index’ (445). The following four situations may arise:
(a) When similarity score is more than seventy percent and sentiment is positive Referring to FIG. 6, when another similar query is already present in ‘Contextual Response Index’ (445) with a similarity score of more than seventy percent and the sentiment is positive, the textual response and video path as given to the corresponding similar earlier query present in the ‘Contextual Response Index’ (445), is provided as final response (475) to the present query of the customer wherein the response contains textual response and video path and goes to user interface.
(b)When similarity score is more than seventy percent, but sentiment is negative Continuing with reference to FIG. 6, when another similar query is already present in ‘Contextual Response Index’ (445) with a similarity score of more than seventy percent but the sentiment is negative, the data in the ‘Contextual Response Index’ (445) is filtered based on geographical location (state) of the customer to provide personalized responses (475).
(c) When similarity score is less than seventy percent, but sentiment is positive Referring to FIG. 7, when another similar query is already present in ‘Contextual Response Index’ (445) with a similarity score of less than seventy percent but the sentiment is positive, the customer query passes through Retrieval Augmented Generation (RAG) module for generation of response. This is followed by generating of Avatar by AI Avatar Generation module which not only responds with text but has also a face of a person and a voice mimicking human voice thus making a customer to feel as is he/she is conversing with a real person.
(d)When similarity score is less than seventy percent, but sentiment is negative Continuing with reference to FIG. 7, when another similar query is present in ‘Contextual Response Index’ (445) with a similarity score of less than seventy percent but the sentiment is negative, the customer query passes through Retrieval Augmented Generation (RAG) module for generation of response. The sentiment-based statistics generated by the sentiment-based statistical response system (450) are appended to the final response. This is followed by generating of Avatar by AI Avatar Generation module which not only responds with text but has also a face of a person and a voice mimicking human voice thus making a customer to feel as is he/she is conversing with a real person.

### Targeted Follow-up System

After customers purchase some F&I products, but not all, the system automatically sends follow-up messages via email and SMS at scheduled intervals. These messages remind the customers that there are additional F&I products available that they can purchase to protect their vehicle. The system will also send the additional coupons as inventive to the customer to add those protections. The system will also send a link from a third party service such as SPP, PayLink that can finance the customer purchased products outside of the original car loan. This strategic follow-up keeps the customer engaged with the brand, nurturing a relationship increasing the likelihood of future interactions. Such automated and intelligent follow-up system represents a significant step forward in personalized marketing and customer relationship management.

While the AI system of the present invention has been described above with reference to an example embodiment thereof, it is to be understood it is susceptible to adaptations, modifications and equivalent changes by those skilled in the art. It is intended that the scope of the present invention be accorded the broadest interpretation so as to encompass all such variant embodiments and equivalent configurations as is permitted under the law.

What is claimed is:

1. AI system for Finance & Insurance products for real-time interaction and generation of textual and conversational response to customer's queries, comprising:
user interface (390) displaying icons (110, 120, 130, 140, 150, 160, 170, 180, 190, 195) representing different Finance & Insurance (F&I) products wherein a customer can access information relating to any of finance & insurance products by clicking on said corresponding representative icon on the display of said user interface, after entering deal ID number (410), wherein said user interface also displays the image (105) of the vehicle being purchased or purchased by the customer, which image is captured from the deal ID of the customer and wherein said user interface also enables a customer to apply for discount coupons won by the customer on certain F&I products, in the games played by the customer during interaction with the system and wherein further said user interface also displays answers to questions frequently asked by the customer regarding F&I products;
a modified Retrieval-Augmented Generation (RAG) module (430) incorporating novel modules and fine-tuned for F&I products for contextualization and rephrasing query wherein said novel modules includes a Langchain's MongoDB chat history function and a custom short-term window memory mechanism wherein said Langchain's MongoDB chat history function enables to retrieve entire chat history for a specific customer from MongoDB database (431) which is indexed by the customer's unique deal ID (410), and wherein custom short-term window memory mechanism enables to generate a customized short-term sliding window (432) of recent chats by means of Pythons'list slicing technique wherein text of present customer's query (405) is reviewed in the context of recent chats contained in said sliding window and is contextualized and rephrased (433) by API call to the Large Language Model (LLM) using said short-term window memory, said user query and prompt engineering;
a module (500) for sentiment analysis and product extraction wherein for sentiment analysis, a fine-tuned transformer model (440), which has been trained on finance and insurance dataset using HuggingFaces's “Trainer” API in Python, is used to analyze the text of the rephrased contextualized query (433) to determine whether the query reflects ‘positive’ or ‘negative’ sentiment of the customer, and:
when the sentiment of the said query is positive, the rephrased query is passed through vector store (510) which identifies the closely-matching product; and
when the sentiment of the contextualized and rephrased query (433) is negative, the system extracts the F&I product based on MiniLM Product Extraction model (530).
a module (540) for generating personalized trivia relating to statistical information relevant to the F&I product extracted as above for negative sentiment and for the geographical location of the customer thereby ensuring state-specific and contextually relevant statistics so as to enable a customer to take a well-informed decision for buying or not buying a F&I product.
a module (470) for AI avatar generation for F&I products, for providing text response as well as an oral response wherein oral response is spoken by an avatar mimicking a person's personality and replicating the person's voice,
a ‘Contextual Response Index (CRI)’ module (445) which stores pre-generated responses and the associated videos path to previous queries for which the response was previously generated by the system thereby enabling the system to quickly reference past dialogues and responses and wherein the module also leverages advanced similarity search algorithms to enable similarity match searches of the current customer query with the queries already present in the ‘Contextual Response Index (CRI)’; and
wherein for enhancing the retrieval process, the embedded queries are integrated into said ‘Contextual Response Index (CRI)’ using Facebook AI Similarity Search (FAISS) function which is optimized for efficient similarity search and clustering dense vectors enabling rapid identification of the closest matches between the presently embedded query and the previously stored vectors in ‘Contextual Response Index (CRI)’.

2. The AI system of claim1 wherein said Large Language Model used is ChatGPT4o and its later versions which is fine-tuned for customer's queries relating to finance and insurance products in the automotive industry.

3. The AI system of claim 1 wherein said transformer model for sentiment analysis is fine-tuned Support Vector Machine (440) which has been fine-tuned for F&I products.

4. The AI system of claim 1 which has adaptive leaning mechanism whereby new customer interactions are populated in the contextual response index enabling continuous updating and adaptation of the system and wherein the process of populating includes Facebook AI similarity search (FAISS) for efficient storage and retrieval of embeddings.

5. The AI system of claim 1, which includes a system to send follow-up messages to customers via email and SMS at scheduled interval for purchasing additional F&I products available and their discount coupons.

6. The AI system of claim 1 which includes Vector Store (510) which stores the data which acts as knowledge base for the system wherein the data includes data collected from brochures, internet and large language models about F&I products.

7. The AI system of claim 1 wherein the system takes 1-2 seconds for providing textual and conversational response to a customer's query as compared to traditional response time of 15-20 seconds.

8. The AI system of claim 1 which enables plurality of customers to interact with the system and can parallelly access information on different F&I products through user interface on their respective tablets made available to them and thus eliminating waiting time for seeking information on different F&I products.

9. The AI system of claim 1 wherein a customer can interact with the system in different languages presently selected from English and Spanish which is extendable to other desired languages, by selecting the language option provided on the top of the display screen of said user interface.

10. The AI system of claim 1 wherein plurality of customers can remotely interact with the system and can access information on different F&I products through their laptop/tablets when the access particulars are shared with them through message or email.

11. A method of operating AI system for finance and insurance products for real-time interaction and generation of textual and conversational responses to customer's queries, comprising:
interacting by a customer with the AI system for accessing information on any of F&I products by viewing said F&I products displayed one by one on the screen of user interface (390) and revisiting any of the F&I products by clicking on representative icon selected from icon (110, 120, 130, 140, 150, 160, 170, 180, 190, 195) displayed on the user interface and also applying for discount coupons won by the customer in the games played by the customer during interaction with the system and entering any additional query (405) on chatbot (300);
contextualization and rephrasing of query by the customer by retrieving entire chat history for a specific customer from MongoDB database (431), generating of short-term sliding window (432) of recent chats by means of Pythons'list slicing technique, reviewing present customer's query (405) in the context of recent chats contained in said sliding window and contextualizing and rephrasing (433) query using prompt engineering and a Large Language Model (520);
subjecting the rephrased query thus obtained to sentiment analysis using a fine-tuned transformer model (440) which has been trained on finance and insurance dataset using HiggingFaces's “Trainer” API in Python; and
comparing text of said rephrased contextualized query with text of another similar query already present in ‘Contextual Response Index’ (CRI) (445) to determine similarity match score, and
when the similarity score between the present query and earlier query present in the ‘Contextual Response Index’ is more than seventy percent and sentiment is positive, textual response and video path as given to the earlier query is provided as final response (475).
when the similarity score between the present query and earlier query present in the ‘Contextual Response Index’ is more than seventy percent but the sentiment is negative, the data in the ‘Contextual Response Index’ (445) is filtered based on geographical location of the customer to provide personalized responses (475).
when similarity score between the present query and earlier query present in the ‘Contextual Response Index’ is less than seventy percent but the sentiment is positive, the response is generated through Retrieval Augmented Generation (RAG) module followed by generating of Avatar by AI Avatar Generation module providing textual and conversational response; and
when the similarity score between the present query and earlier query present in the ‘Contextual Response Index’ is less than seventy percent and also the sentiment is negative, the response is generated through Retrieval Augmented Generation (RAG) module followed by appending of sentiment-based statistics by the sentiment-based statistical response system (450) and generating of Avatar by AI Avatar Generation module providing textual and conversational response.

12. The method of operating AI system of claim 11 wherein said Large Language Model is ChatGPT 4o and its later versions which is fine-tuned for customer's queries relating to finance and insurance products in the automotive industry.

13. The method of operating AI system of claim 11 wherein said transformer model for sentiment analysis is fine-tuned Support Vector Machine (440).

14. The method of operating AI system of claim 11, wherein the system has “Adaptive Learning Mechanism’ which continuously updates said ‘Contextual Response Index (CRI)’ by incorporating therein new customer interaction and the associated video path.

15. The method of claim 14 wherein the process of incorporating new customer interactions in ‘Contextual Response Index (CRI)’ leverages Facebook AI similarity search (FAISS) functions for efficient storge and retrieval of embeddings.

16. The method of claim 11 wherein customer-queries, response generated by Retrieval Augmented Generation (RAG) module and associated video are embedded using a text-embedding-3-large model which transforms textual queries into high-dimensioned vectors which represent their semantic meanings in a numerical format.

17. The method of claim 11 wherein said ‘Contextual Response Index (CRI)’ leverages advanced search algorithms and employs ‘cosine similarity’ to determine the similarity match score between the present query and the query already present in said ‘Contextual Response Index (CRI)’.

18. The method of claim 11 AI avatar supports speech-to-text capabilities enabling a customer to speak his/her queries and Avatar processes the oral query in real-time with spoken answers mimicking a person's personality and human-like voice making a customer to feel as if he/she is conversing with a real person.

19. The method of claim 11 wherein the method includes sending follow-up messages to customers via email and SMS at scheduled intervals for purchasing additional F&I products available and their discount coupons.
